(19) United States
(12) Patent Application Publication
(10) Pub. No.: US 2008/0252804 A1
(43) Pub. Date: Oct. 16, 2008

(54) LIQUID CRYSTAL DISPLAY DEVICE

(75) Inventors: Akihiko SAITOH, Saitama-shi (JP); Hiroyuki Kimura, Fukaya-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology CO., LTD., Tokyo (JP)

(21) Appl. No.: 12/054,887

(22) Filed: Mar. 25, 2008

(30) Foreign Application Priority Data
Apr. 13, 2007 (JP) 2007-106026
Dec. 12, 2007 (JP) 2007-321091

(51) Int. Cl. G02F 1/133

(52) U.S. Cl. 349/39

(57) ABSTRACT

In a multi-gap liquid crystal display device, a capacity of a storage capacitor (Cst) in a transmission region is set to be smaller than that of a storage capacitor (Csr) in a reflection region (Cst<Csr). In addition, a change amount (V1t) of a compensation voltage to be applied to storage capacitor lines in the transmission region is set to be smaller than a change amount (V1r) of a compensation voltage to be applied to storage capacitor lines in the reflection region (V1t<V1r).

### CROSS-REFERENCE TO RELATED APPLICATIONS

This application is based upon and claims the benefit of priority from Japanese Patent Applications No. 2007-106026 filed on Apr. 13, 2007; and No. 2007-321091 filed on Dec. 12, 2007, the entire contents of which are incorporated herein by reference.

### BACKGROUND OF THE INVENTION

1. Field of the Invention

The present invention relates to a liquid crystal display device, and in particular, to a liquid crystal display device provided with a reflection region for displaying an image by reflecting light and a transmission region for displaying an image by transmitting light.

2. Description of the Related Art

Liquid crystal display devices provided with both of a reflection region configured to display an image by reflecting ambient light and a transmission region configured to display an image by transmitting light from a backlight can secure preferable visibility under both bright and dark environments. For this reason, they have been widely used in information terminals such as mobile phones (see, for example, Japanese Patent Application Publication Nos. 2002-303863 and No. 2003-216116). These liquid crystal display devices generally use a so-called multi-gap method (see, for example, Japanese Patent Application Publication No. 2005-189570). In this method, a cell gap (a thickness of a liquid crystal layer) in a reflection region is set to be smaller than that in a transmission region in order to equalize a distance of light passing through the liquid crystal layer.

However, since a cell gap in the reflection region differs from a cell gap in the transmission region, the applied voltage-transmittance characteristic differs between the reflection region and of the transmission region. This causes a problem that gradation differs therebetween even if the same voltage is applied thereto. A gradation difference between the reflection region and the transmission region can be corrected by changing gradation setting of an output of a DAC circuit. However, if a singe IC is used, it is necessary to additionally provide a board for mounting resistances for changing gradation setting.

According to Japanese Patent Application Publication No. 2005-189570, the capacity of the storage capacitor in the transmission region is set to be larger than that in the reflection region in order to correct a gradation difference. However, in the above-described configuration, the transmission region and the reflection region have the liquid crystal capacitors different in size, and thus inevitably have different applied voltage-transmittance characteristics.

### SUMMARY OF THE INVENTION

An object of the present invention is to provide a liquid crystal display device provided with a reflection region and a transmission region, the liquid crystal display being capable of correcting a gradation difference between the reflection region and the transmission region, attributable to cell gaps, without having a board additionally provided thereto.

A liquid crystal display device according to a first aspect of the present invention includes: a first storage capacitor which is disposed in a first region capable of reflection display; and a second storage capacitor which is disposed in a second region capable of transmission display and whose capacitor is smaller than that of the first storage capacitor.

The liquid crystal display device according to the first aspect of the present invention can suppress variations of change amounts of pixel electrode potentials, which are attributable to cell gaps different in the first and second regions, by setting the capacity of the second storage capacitor to be smaller than that of the first storage capacitor.

A liquid crystal display device according to a second aspect of the present invention includes: a first driving circuit configured to drive a storage capacitor which is disposed in a first region capable of reflection display; and a second driving circuit configured to drive a storage capacitor which is disposed in a second region capable of transmission display. The second driving circuit performs capacitively coupled driving by applying a compensation voltage whose change amount is smaller than that of a compensation voltage to be applied from the first driving circuit.

The liquid crystal display device according to the second aspect of the present invention can suppress variations of change amounts of pixel electrode potentials, which are attributable to cell gaps different in the first and second regions, by setting the change amount of the compensation voltage to be applied to the storage capacitor in the second region capable of transmission display to be smaller than that of the compensation voltage to be applied to the storage capacitor in the first region capable of reflection display.

### BRIEF DESCRIPTION OF THE DRAWINGS

FIG. 1 is a circuit block diagram showing the general configuration of a liquid crystal display device according to a first embodiment;

FIG. 2 is a circuit diagram showing the configuration of a pixel of the liquid crystal display device;

FIG. 3A is a voltage waveform diagram showing relationships of a signal line potential, a scanning line potential, a counter electrode potential, and an storage capacity potential;

FIG. 3B is a voltage waveform diagram in which a voltage waveform of a pixel electrode is added to the above voltage waveform diagram;

FIG. 4A is a graph showing a voltage-transmittance characteristic in a liquid crystal display device of a comparative example;

FIG. 4B is a graph showing a voltage-transmittance characteristic in the liquid crystal display device according to the first embodiment; and

FIG. 5 is a circuit block diagram showing the general configuration of a liquid crystal display device according to a second embodiment.

### DESCRIPTION OF THE EMBODIMENTS

### First Embodiment

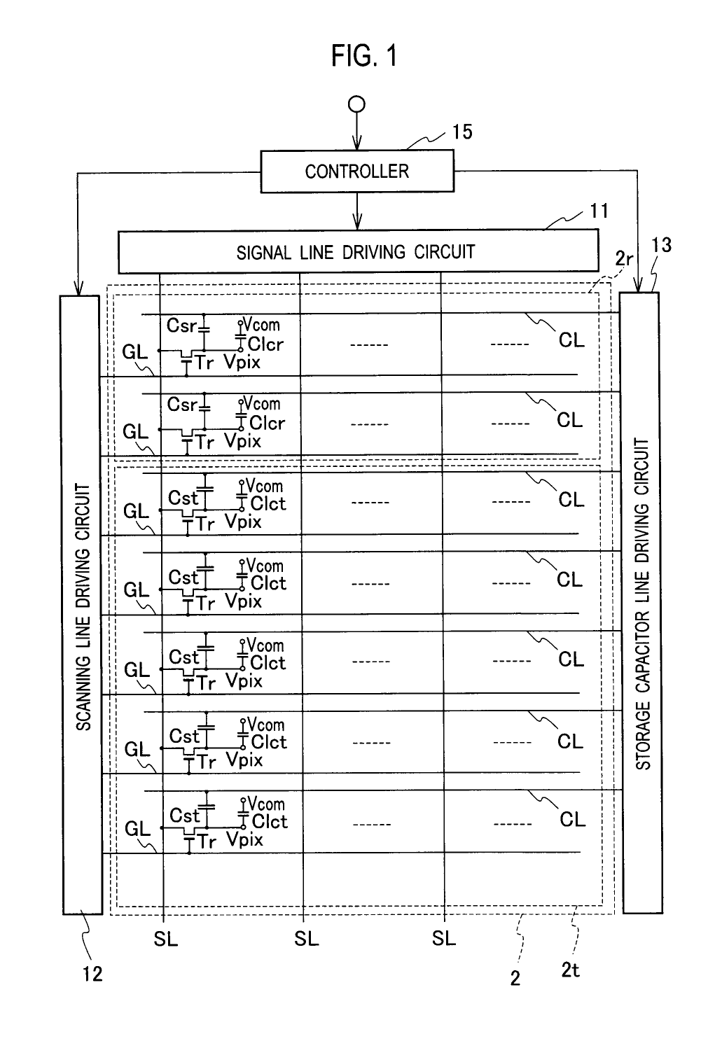

As shown in FIG. 1, in a liquid crystal display device according to a first embodiment of the present invention, a plurality of signal lines SL and a plurality of scanning lines GL are wired so as to intersect each other in a display region 2 on an array substrate. A switching element Tr is disposed in each of intersections of the signal lines SL and the scanning lines GL. A plurality of storage capacitor lines CL is wired for each scanning line GL. The display region 2 has a reflection region 2r (a first region) and a transmission region 2t (a second region).

In the reflection region 2r, an unillustrated pixel electrode capable of reflection display utilizing ambient light and a storage capacitor Csr (a first storage capacitor) are connected to each switching element Tr. In the transmission region 2t, an unillustrated pixel electrode capable of transmission display utilizing light from a backlight and a storage capacitor Cst (a second storage capacitor) are connected to each switching element Tr. The capacity of each storage capacitor Csr in the reflection region 2r is larger than that of each storage capacitor Cst in the transmission region 2t. In order to equalize a distance of light passing through a liquid crystal layer, a cell gap in the reflection region 2r is set to be smaller than that in the transmission region 2t (a multi-gap method).

Furthermore, the liquid crystal display device of the present embodiment includes, on a array substrate, a signal line driving circuit 11 connected to the signal lines SL, a scanning line driving circuit 12 connected to the scanning lines GL, a storage capacitor line driving circuit 13 connected to the storage capacitor lines CL, and a controller 15 connected to each of the above-described circuits. The signal line driving circuit 11 applies a signal voltage to the signal lines SL. The scanning line driving circuit 12 applies a control signal to the scanning lines GL. The storage capacitor line driving circuit 13 applies a compensation voltage to the storage capacitor lines CL. In order to achieve a liquid crystal display device with high resolution, it is desirable that a p-Si TFT is used for the above-described driving circuits.

For example, in a case where the liquid crystal display device of the present embodiment is employed in a display device of a mobile phone, reflection display is used in a region for displaying an amount of battery power remaining, a clock, a signal status, whereas a transmission display is used for displaying photos, and the like in a main region. Thereby, the clock display and the like are easily viewable even in a standby state (when the backlight is off), and a quality of display in the main region at normal state (when the backlight is on) is improved.

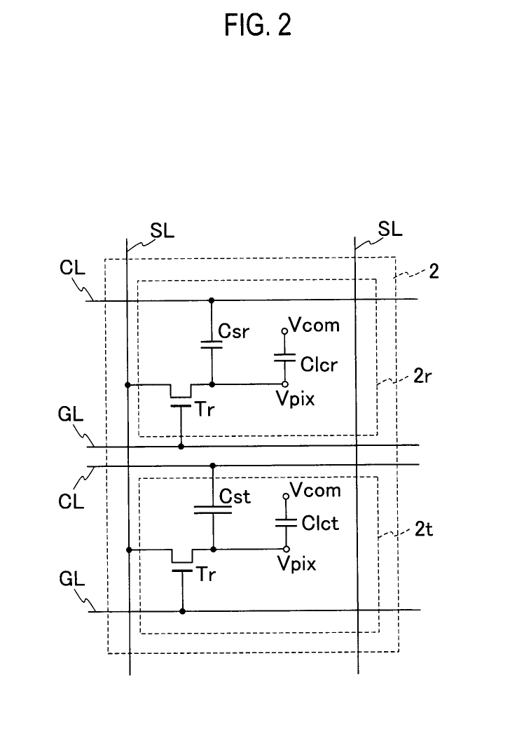

Next, the configuration of a pixel will be described. The circuit diagram of FIG. 2 shows the configuration of a pixel disposed in a vicinity of a boundary between the reflection region 2r and the transmission region 2t. The signal lines SL and the scanning lines GL are wired at substantially right angles to each other. The storage capacitor lines CL are wired in substantially parallel with the scanning lines GL.

One end of the storage capacitor Csr in the reflection region 2r is connected to the switching element Tr and the other end thereof is connected to the storage capacitor line CL. A thin-film transistor (TFT) formed of polycrystal silicon is used for the switching element Tr. The scanning line GL is connected to a gate terminal of the switching element Tr; the signal line SL is connected to a drain terminal of the switching element Tr; and the storage capacitor Csr and the pixel electrode are connected to a source terminal of the switching element Tr in parallel. The pixel electrode in the reflection region 2r is formed by patterning a conductive light reflection film into a predetermined shape. A pixel electrode potential Vpix is applied to the pixel electrode. Although it is not shown in the figure, a counter electrode is disposed on a counter substrate, which faces the pixel electrode with the liquid crystal layer in between. A counter electrode potential Vcom is applied to the counter electrode. In the reflection region 2r, a liquid crystal capacitor Clcr is formed for each pixel.

In the transmission region 2t, a storage capacitor Cst whose capacity is smaller than that of the storage capacitor Csr in the reflection region is disposed (Cst<Csr). One end of the storage capacitor Cst is connected to the switching element Tr and the other end thereof is connected to the storage capacitor line CL. The scanning line GL is connected to a gate terminal of the switching element Tr; the signal line SL is connected to a drain terminal of the switching element Tr; and the storage capacitor Cst and the pixel electrode are connected to a source terminal of the switching element Tr in parallel. A light transmission conductive member, such as indium tin oxide (ITO), is used for the pixel electrode in the transmission region 2t. A cell gap in the transmission region 2t is larger than that in the reflection region 2r. Thus, the liquid crystal capacitor Clct in the transmission region 2t is smaller than the liquid crystal capacitor Clcr in the reflection region 2r (Clct<Clcr).

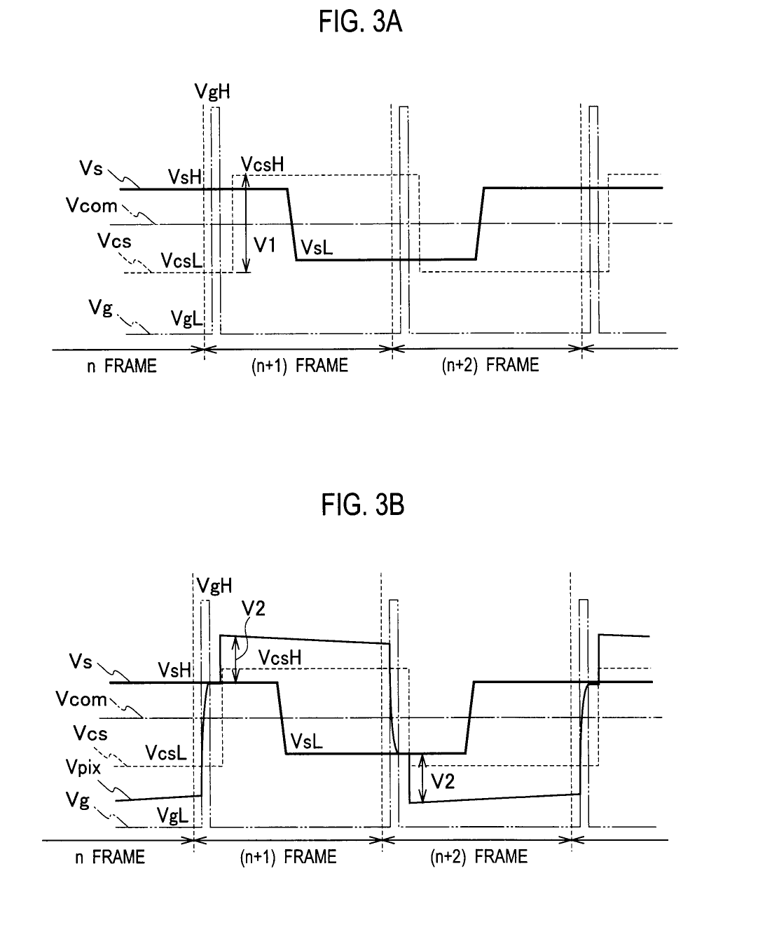

FIG. 3A is a voltage waveform diagram showing relationships of a signal line potential Vs, a scanning line potential Vg, the counter electrode potential Vcom, and a storage capacitor potential Vcs. The signal line driving circuit 11 applies a high-level signal voltage VsH and a low-level signal voltage VsL to the signal lines SL. The scanning line driving circuit 12 applies a high-level control signal VgH and a low-level control signal VgL to the scanning lines GL. The storage capacitor line driving circuit 13 applies a high-level compensation voltage VcsH and a low-level compensation voltage VcsL to the storage capacitor lines CL. A constant counter electrode voltage Vcom is applied to the counter electrode. Reference numeral V1 shows a change amount of potentials of the storage capacitor lines CL.

In an n-th frame, the signal line potential Vs, the storage capacitor potential Vcs, and the scanning line potential Vg are respectively VsH, VcsL, and VgL. In an (n+1) frame, the switching element Tr is turned on when the scanning potential Vg is changed from VgL to VgH. During the period when the switching element Tr is being on, the signal line driving circuit 11 applies a signal voltage to the signal lines SL to write the signal voltage in the pixel electrode. Thereafter, the switching element Tr is turned off when the scanning line potential Vg is changed from VgH to VgL. During the period when the switching element Tr is being off, the storage capacitor line driving circuit 13 changes the storage capacitor potential Vcs from VcsL to VcsH. After that, the signal line potential Vs changes from VsH to VsL.

In an (n+2) frame, the switching element Tr is turned on when the scanning line potential Vg is changed from VgL to VgH. During the period when the switching element Tr is being on, the signal line driving circuit 11 applies a signal voltage to the signal lines SL to write the signal voltage in the pixel electrode. Thereafter, the switching element Tr is turned off when the scanning line potential Vg is changed from VgH to VgL. During the period when the switching element Tr is being off, the storage capacitor line driving circuit 13 changes the storage capacitor potential Vcs from VcsH to VcsL. After that, the signal line potential Vs changes from VsL to VsH. The above-described potential changes are repeated for every frame.

In this manner, in the present embodiment, the signal line driving circuit 11 applies a signal voltage to the signal lines SL to write the signal voltage in the pixel electrode during the period when the switching element Tr is being on. Thereafter, the storage capacitor line driving circuit 13 applies a compensation voltage to the storage capacitor lines CL during the period when the switching element Tr is being off. In such capacitively coupled driving, the pixel electrode potential Vpix to be applied to the pixel electrode is changed by changing the storage capacitor potential Vcs of the storage capacitor line CL to which the storage capacitors Csr and Cst are connected.

Next, the change of the pixel electrode potential Vpix will be described by referring to the voltage waveform diagram of FIG. 3B. FIG. 3B is a diagram in which the pixel electrode potential Vpix is added to FIG. 3A. In an (n+1)-th frame, when the scanning line potential Vg is changed from VgL to VgH, the pixel electrode potential Vpix increases up to VsH. Even after the scanning line potential Vg is returned from VgH to VgL, the pixel electrode potential Vpix substantially maintains the VsH value. Then, when the storage capacitor potential Vcs is changed from VcsL to VcsH, the pixel electrode potential Vpix is changed to be Vpix=VsH+V2. Thereafter, even after the signal line potential Vs changes from VsH to VsL, the pixel electrode potential Vpix substantially maintains VsH+V2.

In an (n+2)-th frame, when the scanning line potential Vg is changed from VgL to VgH, the pixel electrode potential Vpix decreases to VsL. Even after the scanning line potential Vg is returned from VgH to VgL, the pixel electrode potential Vpix substantially maintains the VsL value. Then, when the storage capacitor potential Vcs is changed from VcsH to VcsL, the pixel electrode potential Vpix is changed to be Vpix=VsL−V2. Thereafter, even after the signal line potential Vs is changed form VsL to VsH, the pixel electrode potential Vpix substantially maintains VsL−V2.

Next, the change amount V2 of the pixel electrode potential Vpix will be further described in detail. The change amount V2 of the pixel electrode potential Vpix can be expressed by V2=V1*(Cs/(Cs+Clc+parasitic capacitor)), where the change amount of the storage capacitor potential is V1, the storage capacitor is Cs, and the liquid crystal capacitor is Clc.

The change amount V2r of the pixel electrode potential in the reflection region 2r can be expressed by V2r=V1*(Csr/(Csr+Clcr+parasitic capacitor)), where the change amount of the storage capacitor potential is V1, the storage capacitor is Csr, and the liquid crystal capacitor is Clcr.

Similarly, the change amount V2t of the pixel electrode potential in the transmission region 2t can be expressed by V2t=V1*(Cst/(Cst+Clct+parasitic capacitor)), where the change amount of the storage capacitor potential is V1, the storage capacitor is Cst, and the liquid crystal capacitor is Clct.

In the liquid crystal display device of the present embodiment, in order to equalize a distance of light passing through the liquid crystal layer, a cell gap in the reflection region 2r is set to be smaller than that in the transmission region 2t. Accordingly, the relationship of Clcr>Clct is established between the liquid crystal capacitor Clcr in the reflection region and the liquid crystal capacitor Clct in the transmission region.

In the present embodiment, the capacity of the liquid crystal capacitor Clcr is 0.14 pF and the capacity of the liquid crystal capacitor Clct is 0.10 pF. Thus, the capacity of the storage capacitor Csr in the reflection region is set to be 0.33 pF, and the capacity of the storage capacitor Cst in the transmission region is set to be 0.25 pF so that the capacity of the storage capacitor Cst would be smaller than the capacity of the storage capacitor Csr. In addition, the change amount of the storage capacitor potential V1 is set to be 4.2 V so that the liquid crystal applied voltage would be 3.0 V.

In this manner, by adjusting the storage capacitors Csr and Cst, V1*(Csr/Csr+Clcr+parasitic capacitor))=V1*(Cst/(Cst+Clct+parasitic capacitor)), that is, V2r=V2t can be obtained.

Accordingly, by adjusting the storage capacitors Csr and Cst in the reflection region 2r and the transmission region 2t so as to be Csr>Cst, the change amounts V2r and V2t of the pixel electrode potential Vpix, which are attributable to the cell gaps different in the reflection region 2r and the transmission region 2t, can be equalized. Thereby, it is made possible that a gradation difference between the both regions, which is attributable to the difference of the cell gaps, is corrected on the same substrate.

As described above, according to the present embodiment, the capacity of the storage capacitor Cst in the transmission region 2t is set to be smaller than that of the storage capacitor Csr in the reflection region 2r (Cst<Csr). Thereby, the change amounts of the pixel electrode potentials Vpix, which are attributable to the cell gaps different in the reflection region 2r and the transmission region 2t can be equalized. Thus, it is made to correct a gradation difference between the both regions, which is attributable to the difference of the cell gaps.

Next, to further clarify effects of the present embodiment, a liquid crystal display device of a comparative example will be described. In the liquid crystal display device of the comparative example, storage capacitors are equal in a reflection region and a transmission region (Csr=Cst). Since the relationship of a liquid crystal capacitor Clcr in the reflection region and a liquid crystal capacitor Clct in the transmission region is Clct>Clct, (Csr/(Csr+Clcr+parasitic capacitor))<(Cst/(Cst+Clct+parasitic capacitor)) is obtained.

Thus, the relationship of V2r<V2t is established between change amounts V2r and V2t of the pixel electrode potentials Vpix in the refection region and in the transmission region.

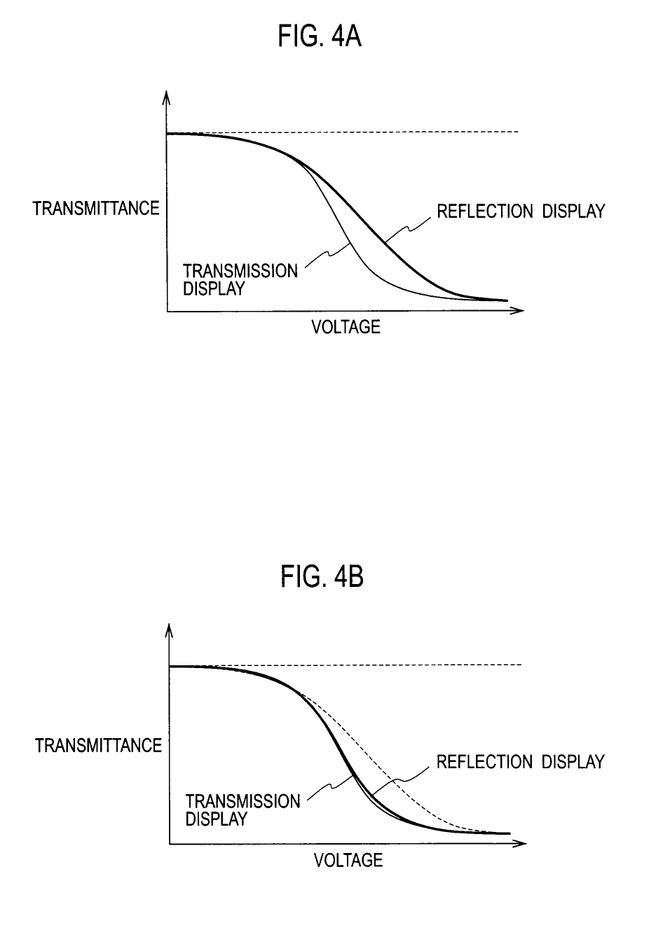

FIG. 4A is a graph showing a voltage-transmittance characteristic in the liquid crystal display device of the comparative example. The voltage-transmittance characteristic of reflection display is shifted to a slower direction than that of transmission display. This indicates that the change amounts V2t and V2r of the pixel electrode potentials Vpix are different in the transmission region 2t and the reflection region 2r, and thereby a gradation difference is generated between displays in the both regions.

FIG. 4B is a graph showing a voltage-transmittance characteristic of the liquid crystal display device of the present embodiment. In the graph, the voltage-transmittance characteristics of the reflection display and the transmission display are substantially equal. This indicates that the change amounts V2t and V2r of the pixel electrode potentials Vpix, which are attributable to the cell gaps different in the transmission region 2t and the reflection region 2r, are made substantially equal, and thereby the gradation difference in the both regions is corrected on the same substrate.

### Second Embodiment

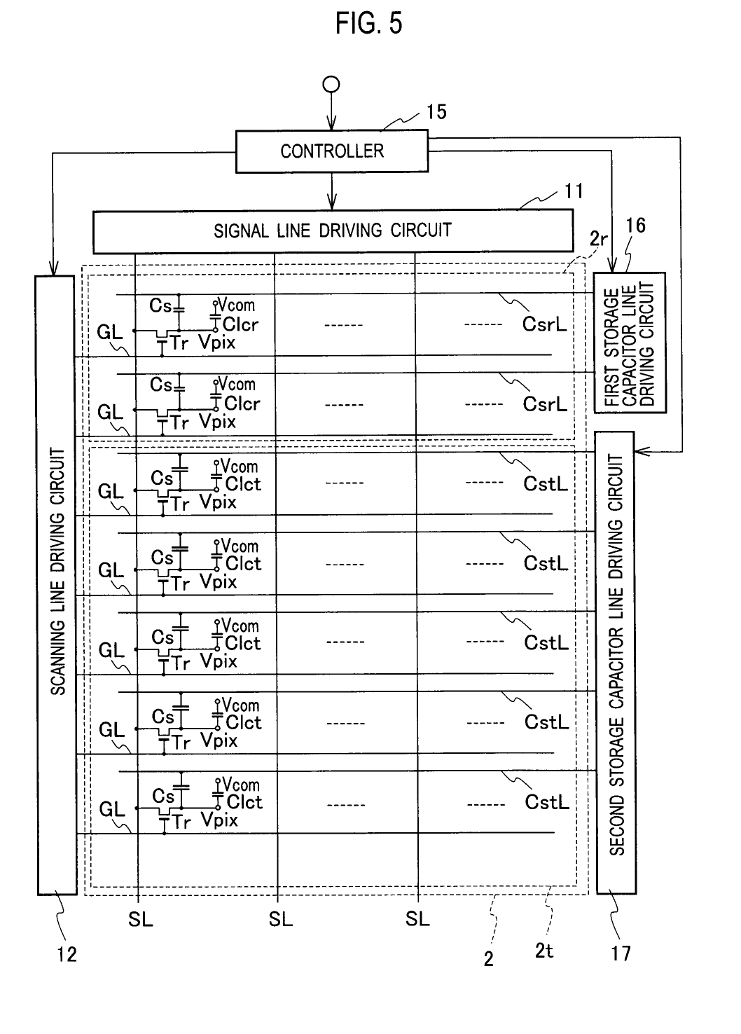

Next, a second embodiment will be described. FIG. 5 is a block diagram showing the configuration of a liquid crystal display device according to the present embodiment. When compared with the liquid crystal display device shown in FIG. 1, the liquid crystal display device shown in FIG. 5 is different in that capacities of storage capacitors Cs disposed respectively in a reflection region 2r and a transmission region 2t are same, and that the storage capacitor driving circuit 13 in FIG. 1 is divided into a first storage capacitor driving circuit 16 and a second storage capacitor driving circuit 17. The first storage capacitor driving circuit 16 drives storage capacitor lines CsrL in the reflection region 2r, whereas the second storage capacitor driving circuit 17 drives storage capacitor lines CstL in the transmission region 2t.

Since a cell gap in the reflection region 2r differs from that in the transmission region 2t, a liquid crystal capacitor Clcr in the reflection region 2r and a liquid crystal capacitor Clct in the transmission region 2t are different. Accordingly, if each of the capacities of the storage capacitors Cs in the reflection region 2r and that in the transmission region 2t are equal, change amounts V2r and V2t of pixel electrode potentials Vpix are different. However, even if the storage capacitors Cs are equal, it is possible that the change amounts V2 of the pixel electrode potentials Vpix in the reflection region 2r and the transmission region 2t are brought closer to each other by differently driving the change amounts V1 of the storage capacitor potentials Vcs in the reflection region 2r and in the transmission region 2t.

For this reason, the first storage capacitor driving circuit 16 and the second storage capacitor driving circuit 17 are provided to separately drive the storage capacitor lines CsrL and CstL by these circuits so that the change amount V1t of the storage capacitor potential in the transmission region 2t would be smaller than the change amount V1r of the storage capacitor potential Vcs in the reflection region 2r. Specifically, the storage capacitor lines CsrL and CstL are driven so as to be V1r*(Cs/(Cs+Clcr+parasitic capacitor))=V1t*(Cs/(Cs+Clct+parasitic capacitor)), that is, V2r=V2t. Thereby, the above-described voltage-transmittance characteristics can be made substantially equal.

In the present embodiment, the storage capacitor lines CsrL and CstL are driven so that the change amount V1r of the storage capacitor potential in the reflection region 2r would be 4.7 V and the change amount V1t of the storage capacitor potential in the transmission region 2t would be 4.2 V, where the storage capacitor Cs is 0.25 pF.

Accordingly, according to the present embodiment, the change amount V1t of a compensation voltage to be applied to the storage capacitor line CstL in the transmission region 2t is set to be smaller than the change amount V1r of a compensation voltage to be applied to the storage capacitor line CsrL in the reflection region 2r. Thereby, variations of the change amounts V2r and V2t of the pixel electrode potentials Vpix, which are attributable to the cell gaps different in the reflection region 2r and the transmission region 2t, can be suppressed.

### Third Embodiment

Next, a third embodiment will be described. The basic configuration of a liquid crystal display device according to the present embodiment is similar to those described in the first and second embodiments except that a pixel electrode in a first region of the present embodiment is a semi-transmissive pixel electrode capable of not only reflection display but also of transmission display.

Here, the relationship of a liquid crystal capacitor Clch in a first region (a semi-transmission region) and a liquid crystal capacitor Clct in a second region (a transmission region) is Clch>Clct, where the liquid crystal capacitor in the first region is Clch. Thus, effects similar to those of the first and second embodiments can be obtained by setting Csh>Cst or V1h>V1t, where the storage capacitor in the first region is Csh and the change amount of the storage capacitor potential Vcs is V1h.

### Fourth Embodiment

Next, a fourth embodiment will be described. The basic configuration of a liquid crystal display device according to the present embodiment is similar to those described in the first and second embodiments except that a pixel electrode in a second region of the present embodiment is a semi-transmission pixel electrode capable of not only transmission display but also of reflection display.

Here, the relationship of a liquid crystal capacitor Clcr in a first region (a reflection region) and a liquid crystal capacitor Clch in a second region (a semi-transmission region) is Clcr>Clch, where the liquid crystal capacitor in the second region is Clch. Thus, effects similar to those of the first and second embodiments can be obtained by setting Csr>Csh or V1r>V1h, where the storage capacitor in the second region is Csh and the change amount of the storage capacitor potential Vcs is V1h.

What is claimed is:

1. A liquid crystal display device, comprising:
a plurality of signal lines and a plurality of scanning lines which are wired to intersect each other;
a switching element disposed in each of intersections of the plurality of signal lines and the plurality of scanning lines;
a plurality of storage capacitor lines which are wired for the respective scanning lines;
a first region in which a pixel electrode capable of reflection display is connected to the switching element;
a second region in which a pixel electrode capable of transmission display is connected to the switching element;
a first storage capacitor having one end connected to the switching element in the first region and the other end connected to the storage capacitor line; and
a second storage capacitor having one end connected to the switching element in the second region and the other end connected to the storage capacitor line, the second storage capacitor having a capacity smaller than the first storage capacitor.

2. A liquid crystal display device, comprising:
a plurality of signal lines and a plurality of scanning lines which are wired to intersect each other;
a switching element disposed in each of intersections of the plurality of signal lines and the plurality of scanning lines;
a plurality of storage capacitor lines which are wired for the respective scanning lines;
a first region in which a pixel electrode capable of reflection display is connected to the switching element;
a second region in which a pixel electrode capable of transmission display is connected to the switching element;
a storage capacitor having one end connected to the switching element and the other end connected to the storage capacitor line;
a first driving circuit configured to perform capacitively coupled driving by applying a compensation voltage to the storage capacitor lines in the first region; and
a second driving circuit configured to perform capacitively coupled driving by applying a compensation voltage to the storage capacitor lines in the second region, the compensation voltage having smaller change amount than the compensation voltage applied by the first driving circuit.

3. The liquid crystal display device according to claim 1, wherein the pixel electrode in the first region is a semi-transmission pixel electrode capable of transmission display as well as reflection display.

4. The liquid crystal display device according to claim 1, wherein the pixel electrode in the second region is a semi-transmission pixel electrode capable of reflection display as well as transmission display.

5. The liquid crystal display device according to claim 1, further comprising a driving circuit configured to perform capacitively coupled driving for changing a potential of the storage capacitor line during a period when the switching element is being off.
